(19) United States
(12) Patent Application Publication
(10) Pub. No.: US 2025/0318623 A1
(43) Pub. Date: Oct. 16, 2025

(54) HAND-HELD, DEBRIS-COLLECTING IMPLEMENT AND DEBRIS CLEANING DEVICE

(71) Applicants: RALPH E. POCINO, MERCERVILLE, NJ (US); ARMANDO R. POCINO, MERCERVILLE, NJ (US)

(72) Inventors: RALPH E. POCINO, MERCERVILLE, NJ (US); ARMANDO R. POCINO, MERCERVILLE, NJ (US)

(21) Appl. No.: 18/445,054

(22) Filed: Mar. 22, 2023

Related U.S. Application Data
(63) Continuation-in-part of application No. 17/803,456, filed on Jul. 20, 2022, now Pat. No. 12,296,497.

(51) Int. Cl. A45D 27/46; A46B 17/06; A47L 9/00

(52) U.S. Cl. CPC A45D 27/46; A46B 17/06; A47L 9/00; A46B 2200/1066

(57) ABSTRACT

An attachable implement snapper device for removing debris from a debris-collecting hand-held implement by spring-loaded impact. It includes a) a cantilevered push mechanism having a thumb-press end, an opposing snapper end, and a pivot point between said ends, for manual push and release action; and, b) a spring connected thereto, positioned to bias the push mechanism snapper end against said implement, with sufficient tension to create an impact when the push mechanism is pressed toward said implement and released. There is also a motorized debris-releasing cleaning device in combination with a hand-held, debris-collecting implement.

### REFERENCE TO RELATED APPLICATIONS

This application is a continuation-in-part of U.S. utility patent application Ser. No. 17/803,456, filed on Jul. 20, 2022, titled “Razor Blade Snapper Cleaning Device”, filed by the same inventors as herein.

### BACKGROUND OF INVENTION

### a. Field of Invention

The parent application cited above describes an invention that relates generally to the problem of manual razors (electric razors excluded) that inherently clog up with cut hair and other shaving debris (“debris” may be water, shaving cream, dried shaved skin, razor lubricant, combinations thereof, etc.). The problem persists for both single blade razors and multi-blade razors. Users of manual razors typically repeatedly bang the razor against a sink, or tile or countertop or palm, with possible damage to the razor and/or to the item receiving the bang. In addition, there is not much control over where the cut hair and debris end up (in the sink, dripping down the razor, on the counter, on the tile or combinations thereof). The parent case invention is directed to devices that are dedicated to the removal of cut hair and debris, using a pull and release device that causes a controlled bang (impact/vibration) that loosens and releases the lodged cut hair and debris.

The present invention relates to alternative devices for the same purpose (cleaning debris from razors), as well as for removal of debris from other hand-held implements, such as brushes, tooth brushes and other implements described herein. In some embodiments, the present invention includes a motorized mechanism, specifically, a motor with a drive shaft; and a movement bar connected to the motor drive shaft, such that when said motor is on, the movement bar imparts shaking movement to said implement to remove debris therefrom.

In other embodiments, the present invention has no motor and is an implement snapper device for removing debris from a hand-held, debris collecting impolements by spring-loaded impact, that includes: a cantilevered push mechanism having a thumb-press end, an opposing snapper end, and a pivot point between the ends, for manual push and release action; and, a spring connected to, or a part of, the snapper end of the push mechanism, the spring connected to the implement, and the spring positioned to bias the push mechanism snapper end toward the implement. The spring has sufficient tension to create an impact against the implement when the push mechanism is pressed toward the implement and released, to thereby cause debris to release from the implement.

### b. Description of Related Art

The following patents are representative of the field pertaining to the present invention:

U.S. Pat. No. 4,344,227 to Chen et al. describes an improved twin blade razor system having a unitary member positioned between the pair of blades for both spacing the blades and ejecting shaving debris from that space. The unitary member, which may conveniently be of injection molded plastic, includes a spacer portion, an ejector portion, and biasing apparatus connecting the ejector portion and the spacer portion for biasing the ejector portion to a normally retracted position relative to the blades and spacer. The ejector portion is manually displaceable to an advanced ejecting position. The biasing portion may be one or more beam springs connected and configured to reduce distortion and/or stressing of the relatively moving portions of the member during actuation. This device relies upon ejection, that is, pushing the cut hair out of its lodged position and is necessarily not transferable to a second razor.

U.S. Pat. No. 4,205,437 Chen et al. describes an improved twin blade razor system having a unitary member positioned between the pair of blades for both spacing the blades and ejecting shaving debris from that space. The unitary member, which may conveniently be of injection molded plastic, includes a spacer portion, an ejector portion, and biasing means connecting the ejector portion and the spacer portion for biasing the ejector portion to a normally retracted position relative to the blades and spacer. The ejector portion extends across in front of but is substantially discontinuous behind the spacer portion, resulting in a compact front-to-rear configuration for the unitary member which may be housed in a relatively compact twin blade system. The ejector portion is manually displaceable to an advanced ejecting position. The biasing portion may be one or more beam springs connected and configured to reduce distortion and/or stressing of the relatively moving portions of the member during actuation. This device relies upon ejection, that is, pushing the cut hair out of its lodged position and is necessarily not transferable to a second razor.

U.S. Pat. No. 4,047,296 to Ishida et al. describes a two-edge shaving blade unit having a member for ejecting shaved hair particles and other matter deposited in and clogging a space between the leading and following cutting edges. The upper and lower blade elements are fixed between a platform and a cap portion in a parallel and spaced relation with a spacer interposed there between. The ejecting member is retained between the upper and lower blade elements and is loosely fitted around the spacer in a manner displaceable between advanced and retracted positions. The cap portion has a resilient rear wall having a knob at its laterally intermediate portion, and to this knob is connected the ejecting member. The ejecting member can be displaced forwardly into the advanced position when the knob is pushed manually so as to eject the hair particles and other matter deposited in and clogging the space between the leading and following cutting edges. Further, when the pushing force on the knob is removed, the knob and thus the ejecting member are displaced to the original retracted position with the resilient force of the resilient rear wall. This device relies upon ejection, that is, pushing the cut hair out of its lodged position and is necessarily not transferable to a second razor.

U.S. Pat. No. 3,972,114 to Chao et al. describes a self-cleaning mechanism arranged between the blades of a twin blade razor, whereby after use, the area between the blades which fill with human hair and soap, can be made clean and free of debris by the movement of the cleaning mechanism with a person's fingers.

U.S. Pat. No. 2,715,267 to G. E. Force describes a safety razor assembly with components that include blade clamping elements that can permit changing of blades by opening and closing of various elements of a loading magazine.

U.S. Design Pat. No. Des. 255,163 to Chen describes a safety razor cartridge with clean-out device. It appears as a press button device (that perhaps pushes the cut hair out), and not a pull and release snapping device, as in the present invention

Notwithstanding the prior art, the present invention is neither taught nor rendered obvious thereby.

### SUMMARY OF INVENTION

The present invention is directed to, in combination, a hand-held debris-collecting implement with a cleaning device, the cleaning device for removing debris from the implement by a vibrating-type shaking movement. It includes: a) a hand-held, debris-collecting implement having a handle end and a working end; and b) a cleaning device functionally connected to the implement, the cleaning device including: (i) a motor with a drive shaft; (ii) a power supply connected to the motor; (iii) an on-off switch connected to the power supply; and (iv) a movement bar connected to the motor drive shaft such that when the motor is turned on, the movement bar shakes and imparts shaking movement to the implement to remove debris therefrom. The term “movement bar” as used herein should be taken broadly as to its shape. The movement bar may be a weight that will cause vibration when moved by the motor drive shaft. The shaft rotates, but the bar movement caused by the shaft may be rotational (such as an off centered piece attached to the drive shaft), or may be reciprocal (such as a living spring or other movement piece that is pushed and released by a shaft with a contact protrusion). The ability to cause vibration with a small motor is well within the skill of the artisan and any functional vibrator may be attached or connected to the drive shaft without exceeding the scope of the present invention.

In some embodiments, the combination of implement and cleaning device hand-held debris-collecting implement is selected from the group consisting of a shaver, a brush, a mini-vacuum cleaner, and a toothbrush, and wherein the debris is selected from the group consisting of hair, shaving solution, dirt, paint, toothpaste and combinations thereof.

In some embodiments of the present invention combination of implement and cleaning device, the movement bar is an angled bar attached to the drive shaft of the motor and is spun by the motor to create the shaking movement. In some other embodiments. The motor shaft has a rotatable cam attached thereto, and the movement bar has opposing ends and wherein one end is grounded and the opposite end is ungrounded and adjacent the cam for reciprocal contact and release to create the shaking movement.

In some embodiments, the cleaning device is functionally connected and permanently connected to the hand-held, debris-collecting implement. In others, the cleaning device is a stand-alone device and is functionally and removably connected to hand-held, debris-collecting implement.

One preferred embodiment is the combination of implement and cleaning device wherein the hand-held, debris-collecting implement is a shaver. In other embodiments, the hand-held, debris-collecting implement is a brush of any sort, such as a hair brush, a cleaning brush, a pet grooming brush, a dust pan brush, or a toothbrush.

Other broad embodiments of the present invention are non-motorized debris-removal cleaning devices. Thus, the present invention also includes an implement snapper device for removing debris from a debris-collecting hand-held implement by spring-loaded impact, the device being adapted for functional connection to the implement. It includes: a) a cantilevered push mechanism having a thumb-press end, an opposing snapper end, and a pivot point between the ends, for manual push and release action; and, b) a spring connected to, or a part of, the snapper end of the push mechanism, the spring connected to one of the device and an implement to which it may be attached, and the spring positioned to bias the push mechanism snapper end toward and against the implement, the spring having sufficient tension to create an impact against the implement when the push mechanism is pressed toward the implement and released, to thereby snap against the implement and to thereby cause debris to release from the implement.

In some embodiments of the invention, the snapper device further includes, in combination, an implement, and the push mechanism is attached to a hand-held debris-collecting implement that is selected from the group consisting of a shaver, a brush, a mini-vacuum cleaner, and a toothbrush, and wherein the debris is selected from the group consisting of hair, shaving solution, dirt, paint, toothpaste and combinations thereof. In some of these embodiments, the push mechanism is fixedly attached to the implement and in others, it is removably attached to it. In some cases, there is at least one attachment component on the push mechanism for attachment thereof to the implement. In some embodiments, the attachment component is selected from the group consisting of a rigid yoke, a flexible yoke, a clip, a latch and a flexible band. In some cases, the attachment component is two attachment components, and are flexible bands.

In some embodiments, the snapper device further includes: c.) a snapper device housing that houses the push mechanism and spring; and, d.) a strike plate located opposite the snapper end of the push mechanism.

Additional features, advantages, and embodiments of the invention may be set forth, included or apparent from consideration of the following detailed description, drawings, and claims. As can be seen, the present invention devices may be presented separately from the implements to which they apply. In those cases, the present invention devices may be moved from implement to implement, as desired. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a block diagram illustrating some of the features of the present invention devices;

FIG. 2 shows a block diagram illustrating some other features, details and different embodiments of the present invention devices;

FIG. 3 is a top view of a present invention razor implement and implement snapper device;

FIG. 4 is a side view of the present invention razor implement and implement snapper device shown in FIG. 3 above;

FIG. 5 shows a side view of the present invention device shown in FIGS. 3 and 4, except that this Figure shows the device in use, being pushed down on the operable end of the razor (now in the firing position) about to be released for impact;

FIG. 6 shows the same implement, but wherein the user has moved the thumb back to release the impact end to contact the implement by snapping against it to release debris;

FIG. 7 shows a top view of an alternative present invention device wherein the debris-releasing device is motorized and attached to a shaver (razor);

FIG. 8 shows a side view of an alternative present invention device wherein the debris-releasing device is motorized and attached to a toothbrush;

FIG. 9 shows a side view of an alternative present invention device wherein the debris-releasing device is motorized and attached to a brush, such as a cleaning brush;

FIG. 10 shows a side view of an alternative present invention device wherein the debris-releasing device is motorized and attached to a hand-held vacuum; and,

FIGS. 11, 12 and 13 illustrate a present invention embodiment in which the non-motorized snapper is attached to a toothbrush, a brush and a vacuum cleaner, respectively.

### DETAILED DESCRIPTION OF THE EMBODIMENTS

Referring now in detail to the drawings wherein like reference numerals designate corresponding parts throughout the several views, various embodiments of the present invention are shown.

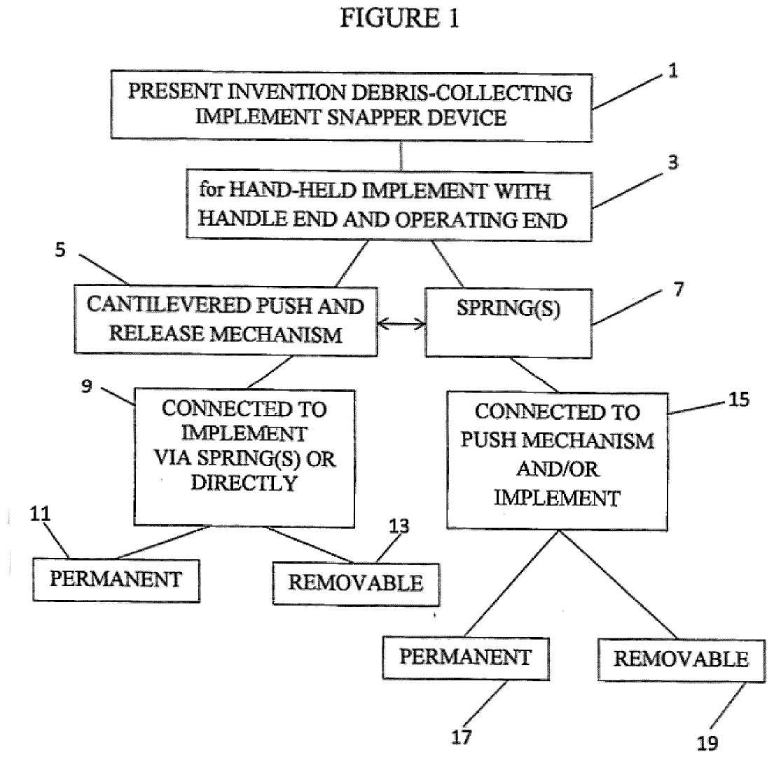

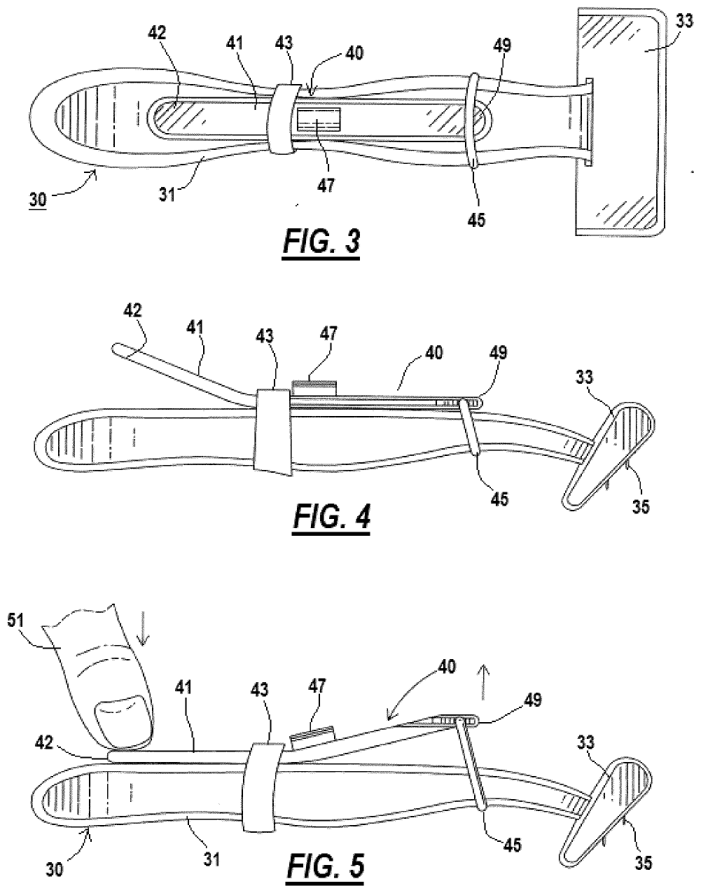

FIG. 1 is a block diagram illustrating some of the features of the present invention snapper device, block 1, for cleaning hand-held implements, block 3. The snapper device includes a cantilevered push and release mechanism, block 5, with one or more springs, block 7. Block 7 springs are connected to the push mechanism or to both, block 15. The cantilevered push and release mechanism is connected to the implement via springs or directly, block 9 and the connection may be permanent, block 11, or removable, block 13. Likewise, the one or more springs, block 15, may be permanently attached, block 17 or removably attached, block 19. On efficient arrangement is to have the cantilevered push and release mechanism attached by a spring, such as an elastic band, and to have a second elastic band used to further hold the device on the implement, and to bias the snap end of the cantilevered mechanism against the implement, as shown in FIG. 3 forward, below.

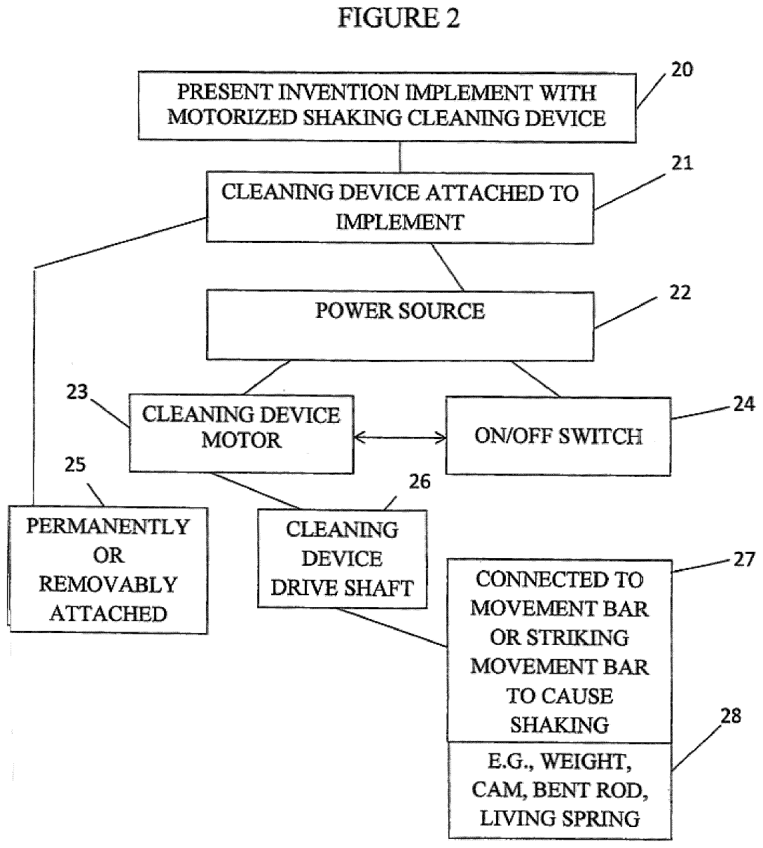

FIG. 2 shows a block diagram illustrating some other features and embodiments of different present invention implement with motorize shaking cleaning device 20. This present invention combination hand-held, debris-collecting implements with motorized shaking cleaning devices of FIG. 2 represent alternative embodiments. Thus, there is a cleaning device that is attached to the implement, block 21, which may be permanently or removably attached, block 25. The cleaning device 21 will include a power source, such as a battery or dry cell, and in some cases, a connection to an outside power source, such as AC or DC power line. The power source is connected to an on/off switch, block 24 which is connected to cleaning device motor, block 23. This motor has a drive shaft, block 26 which is connected to a movement bar or is striking a movement bar, to cause shaking (vibration), which provides sufficient shaking to cause release of debris from the hand-held implement.

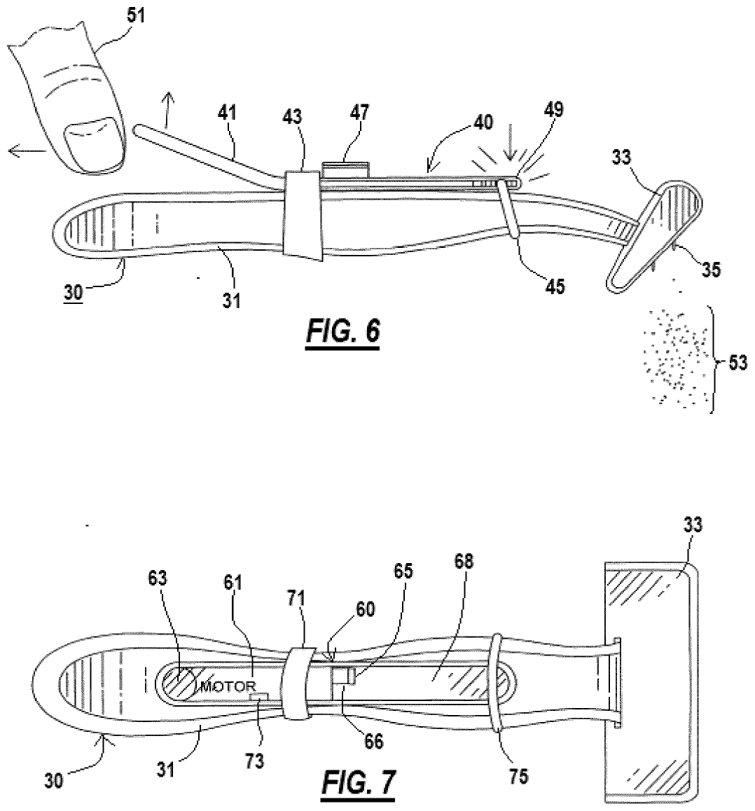

FIG. 3 is a top view of a present invention implements, in this case, razor 30 and implements snapper device 40. FIG. 4 is a side view of the present invention razor 30 and snapper device 40 shown in FIG. 3 above, with identical components being identically numbered. Razor 30 is a disposable or non-disposable razor that may have detachable or non-detachable razor housing or razor blades. As shown, it has a handle 31, a razor housing 33, and replaceable dual blades 35. Razor snapper 40 includes cantilevered push and release mechanism 41. This mechanism has uplifted press and release end 42 and a snap end 49. Band 43 hold the mechanism in place with sufficient elasticity or spacing to permit end 42 to be press down against razor 30 (see FIG. 5) there is a stop 47 and snap end is connected to a spring 45 which is connected to razor 30, as shown. As seen in FIG. 5, when a user 51 presses down on end 42, snap end 49 is uplifted and spring 45, in this case an elastic band, is stretched. When the user 51 releases his thumb by sliding off the mechanism, spring 45 snaps end 49 against razor 30, as shown in FIG. 6, releasing debris 53.

FIG. 7 shows a top view of the present invention combination motorize snapper device and implement. Here, razor 30 shown in FIGS. 3 through 6 is the implement, and motorized debris-releasing cleaning device 60 are shown. Cleaning device 60 has a small motor 61, a battery 63, and an on/off switch 73. The motor 61 has a rotating drive shaft 66, with an offset weight 65. Transparent housing 68 shows the functional components. Bands 71 and 75 hold cleaning device 60 in place. When motor 61 is turned on, the rotating weight causes sufficient vibration to remove debris from the razor 30. (In this Figure the parts of the razor 30 are the same as described above.)

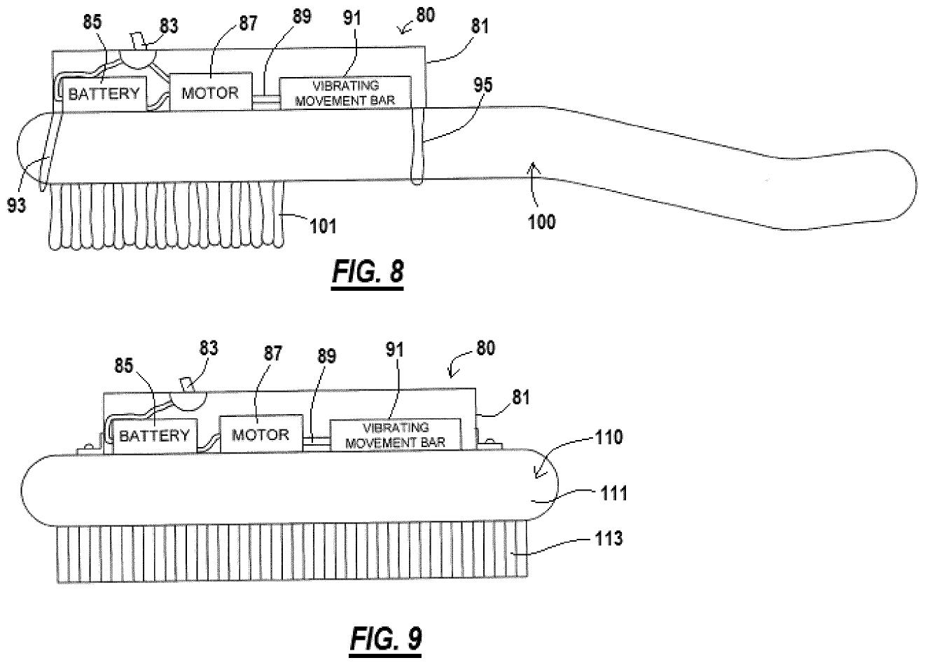

FIG. 8 shows a side view of toothbrush 100 and motorized vibrating cleaning device 80. Toothbrush 100 has a functional end with bristles 101. Cleaning device 80 has housing 81, on/off switch 83, battery 85, motor 87, shaft 89 and vibrating movement bar 91. When cleaning device 80 is turned on, the motor and shaft cause vigorous movement of the vibrating movement bar 91 that is sufficient to shake loose debris on bristles 101.

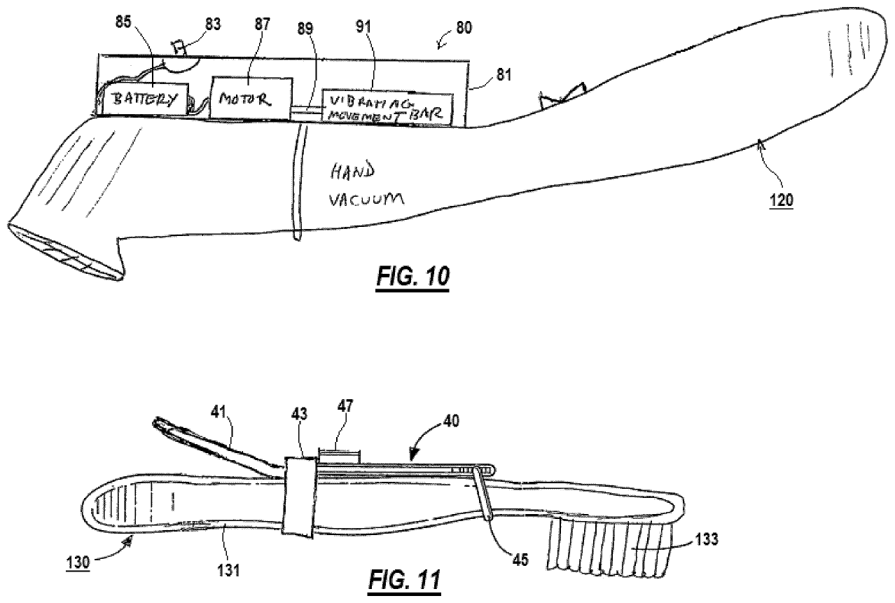

FIG. 9 show a side view of a brush 110 that includes handle 111 and bristles 113. This brush 110 may be any type of brush, including a cleaning brush or a grooming brush. Permanently mounted on the top of handle 111 is the same motorized vibrating cleaning device 80 as shown in FIG. 8 above and FIG. 10 below wherein like parts are like numbered. Also, the functionality of cleaning device 80 is the same for FIGS. 8, 9 and 10. FIG. 10 shows the same present invention cleaning device 80 on hand-held vacuum 120 and the cleaning device 80 has the same numbered parts as previously and functions in the same manner.

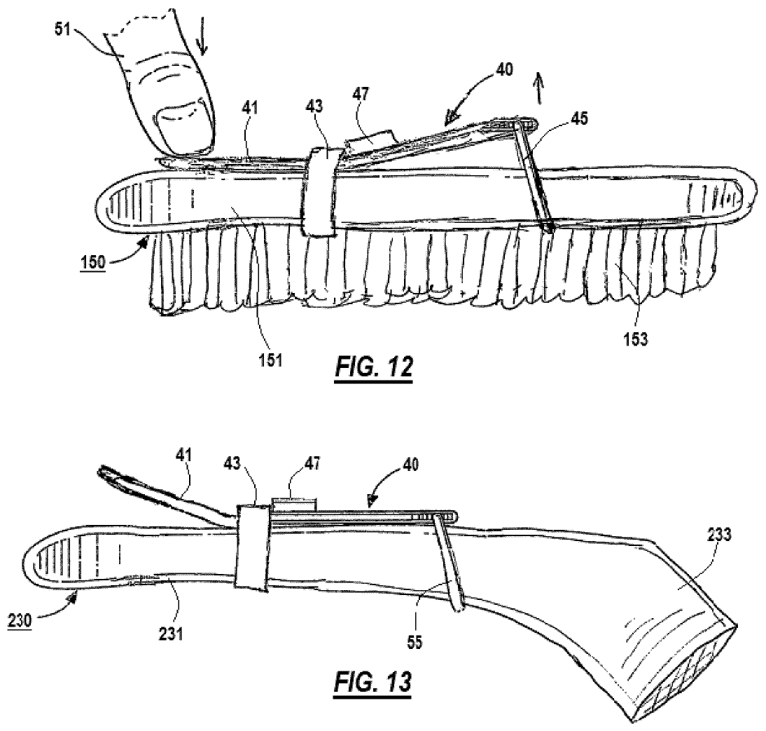

FIGS. 11, 12 and 13 illustrate side views of the same motorized vibrating cleaning device 80 as shown above, with the same numbered parts and the same functionality as described above, but mounted on toothbrush 130 (with handle 131 and bristles 133); on brush 150 (with handle 151 and bristles 153; and on hand-held minivac 230 (with handle 231 and functional end 233), respectively for these Figures.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. In combination, a hand-held debris-collecting implement with a cleaning device, said cleaning device for removing debris from said implement by a shaking movement, which comprises:
a) a hand-held, debris-collecting implement having a handle end and a working end;
b) a cleaning device functionally connected to said implement, said cleaning device including: (i) a motor with a drive shaft; (ii) a power supply connected to said motor; (iii) an on-off switch connected to said power supply; and (iv) a movement bar connected to said motor drive shaft such that when said motor is turned on, said movement bar shakes and imparts shaking movement to said implement to remove debris therefrom.

2. The combination of implement and cleaning device of claim 1 wherein hand-held debris-collecting implement is selected from the group consisting of a shaver, a brush, a mini-vacuum cleaner, and a toothbrush, and wherein said debris is selected from the group consisting of hair, shaving solution, dirt, paint, toothpaste and combinations thereof.

3. The combination of implement and cleaning device of claim 1 wherein said movement bar is an angled bar attached to said drive shaft of said motor and is spun by said motor to create said shaking movement.

4. The combination of implement and cleaning device of claim 1 wherein said motor shaft has a rotatable cam attached thereto, and said movement bar has opposing ends and wherein one end is grounded and the opposite end is ungrounded and adjacent said cam for reciprocal contact and release to create said shaking movement.

5. The combination of implement and cleaning device of claim 1 wherein said cleaning device is functionally connected and permanently connected to hand-held, debris-collecting implement.

6. The combination of implement and cleaning device of claim 1 wherein said cleaning device is a stand-alone device and is functionally and removably connected to hand-held, debris-collecting implement.

7. The combination of implement and cleaning device of claim 1 wherein said hand-held, debris-collecting implement is a shaver.

8. The combination of implement and cleaning device of claim 1 wherein said hand-held, debris-collecting implement is a hair brush.

9. The combination of implement and cleaning device of claim 1 wherein said hand-held, debris-collecting implement is a toothbrush.

10. The combination of implement and cleaning device of claim 1 wherein said hand-held, debris-collecting implement is a cleaning brush.

11. An implement snapper device for removing debris from a debris-collecting hand-held implement by spring-loaded impact, said device being adapted for functional connection to said implement, which comprises:
a) a cantilevered push mechanism having a thumb-press end, an opposing snapper end, and a pivot point between said ends, for manual push and release action; and,
b) a spring connected to, or a part of, said snapper end of said push mechanism, said spring connected to one of said device and an implement to which it may be attached, and said spring positioned to bias said push mechanism snapper end toward and against said implement, said spring having sufficient tension to create an impact against said implement when said push mechanism is pressed toward said implement and released, to thereby snap against said implement and to thereby cause debris to release from said implement.

12. The snapper device of claim 11 wherein the snapper device further includes an implement, and the snapper device further includes, in combination, an implement, and said push mechanism is attached to a hand-held debris-collecting implement that is selected from the group consisting of a shaver, a brush, a mini-vacuum cleaner, and a toothbrush, and wherein said debris is selected from the group consisting of hair, shaving solution, dirt, paint, toothpaste and combinations thereof,
said push mechanism is fixedly attached to a shaver.

13. The snapper device of claim 12 wherein said push mechanism is fixedly attached to said implement.

14. The snapper device of claim 11 wherein said pull mechanism is removably attachable to said implement and includes at least one attachment component on said push mechanism for attachment thereof to said implement.

15. The razor snapper device of claim 14 wherein said attachment component is selected from the group consisting of a rigid yoke, a flexible yoke, a clip, a latch and a flexible band.

16. The snapper device of claim 15 wherein said attachment component is two attachment components, and are flexible bands.

17. The snapper device of claim 11 wherein hand-held debris-collecting implement is selected from the group consisting of a shaver, a brush, a mini-vacuum cleaner, and a toothbrush, and wherein said debris is selected from the group consisting of hair, shaving solution, dirt, paint, toothpaste and combinations thereof.

18. The snapper device of claim 11, which further includes:
c.) a snapper device housing that houses said push mechanism and spring; and,
d.) a strike plate located opposite said snapper end of said push mechanism.

19. The snapper device of claim 18 wherein said housing is fixedly attached to said implement.

20. The snapper device of claim 18 wherein said housing is removably attached to said implement.
